(19) United States
(12) Patent Application Publication
(10) Pub. No.: US 2022/0258386 A1
(43) Pub. Date: Aug. 18, 2022

(54) MOLDING PROCESS FOR FORMING THERMOPLASTIC ARTICLES

(71) Applicant: ABC TECHNOLOGIES INC., Toronto (CA)

(72) Inventors: Sean SANJABI, Richmond Hill (CA); Sunny MOTWANI, Toronto (CA)

(21) Appl. No.: 17/627,224

(22) PCT Filed: Jul. 16, 2020
(86) PCT No.: PCT/CA2020/050991

§ 371 Date: Jan. 14, 2022

Related U.S. Application Data
(60) Provisional application No. 62/875,436, filed on Jul. 17, 2019.

(51) Int. Cl. B29C 45/00; B29C 45/04; B29C 45/13

(52) U.S. Cl. CPC B29C 45/006; B29K 2101/12; B29C 45/13; B29C 45/0416

(57) ABSTRACT

Provided is a molding system for molding a thermoplastic article. The molding system comprises a first mold half and a second mold half. The first and second mold halves together define a plurality of molding cavities in a first closed position. The plurality of cavities serve to mold a corresponding plurality of article components in a first molding stage. Subsequent the first molding stage, the first mold half is displaceable relative to the second mold half to align the plurality of article components formed during the first molding stage. During a second molding stage, the first and second mold halves are closed to a second closed position, to engage and bond together the plurality of article components into a finished thermoplastic article.

### FIELD

The present invention pertains to thermoplastic injection molding for forming articles, and in particular for forming hollow articles.

### BACKGROUND

Injection molded hollow objects including washer bottles, surge tanks, diesel bottles, air boxes, air ducts, washer bottles for electrical and autonomous cars, certain HVAC ducts for electrical and autonomous cars, and others are among parts that are usually manufactured via a multi-stage process. Initially the two halves of the hollow object are injection molded either separately or in a family tool, and upon exiting the tool and in a secondary press the two halves are welded together.

This multi-stage process can be both financially and energy intensive, as it includes, inter alia, secondary welding equipment cost, manpower, utility and production cell floor space. Furthermore, the secondary process adds to potential quality side effects on its own including final part warpage and excessive displacement of the semi molten material resulting in weak weld and/or poor sealing performance. To accommodate welding process duration, the cycle time for preparing the injection molded halves is sometimes extended artificially.

In view of the foregoing, it would be beneficial to have a process for manufacturing a hollow article within an injection molding environment, which foregoes the secondary welding process for final assembly.

### SUMMARY

According to an aspect of the disclosure, provided is a molding system for molding a thermoplastic article. The molding system comprises a first mold half and a second mold half. The first and second mold halves together define a plurality of molding cavities in a first closed position. The plurality of cavities serve to mold a corresponding plurality of article components in a first molding stage. Subsequent the first molding stage, the first mold half is displaceable relative to the second mold half to align the plurality of article components formed during the first molding stage. During a second molding stage, the first and second mold halves are closed to a second closed position, to engage and bond together the plurality of article components into a finished thermoplastic article.

According to a further aspect of the disclosure, provided is a process for molding a thermoplastic article in a molding system. The process comprises a first stage in which two or more article components are formed in separate molding cavities. The process also comprises a second stage in which the molding system changes in configuration to align and bring into engagement the two or more article components to permit for bonding therebetween. Each of the two or more article components are provided with a bonding flange that serves as the interface between components to be bonded together. Throughout both the first stage and the second stage the bonding flange is maintained at substantially the molding temperature of the thermoplastic being used, until the thermoplastic article is formed.

### BRIEF DESCRIPTION OF THE DRAWINGS

The foregoing and other features and advantages of the invention will be apparent from the following description of embodiments thereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1a illustrates a molding system at a first step in the molding process, wherein a first mold half and a second mold half are aligned in a first open position.

FIG. 1b illustrates the molding system of FIG. 1a at a second step in the molding process, wherein the first and second mold halves are in a first closed position, prior to the introduction of thermoplastic melt.

FIG. 1c illustrates the molding system of FIG. 1a at a third step in the molding process, wherein the first and second mold halves are in the first closed position, showing the introduction of thermoplastic melt into first and second cavities.

FIG. 1d illustrates the molding system of FIG. 1a at a fourth step in the molding process, wherein the first and second mold halves are opened to the first opened position, with formed first and second article components remaining in the molding system.

FIG. 1e illustrates the molding system of FIG. 1a at a fifth step in the molding process, wherein the first and second mold halves are moved to a second opened position in which the second article component is positioned in-line with the first article component.

FIG. 1f illustrates the molding system of FIG. 1a at a sixth step in the molding process, wherein the first and second mold halves are closed to a second closed position in which a bonding flange of the first article component engages and bonds to a bonding flange of the second article component.

FIG. 1g illustrates the molding system of FIG. 1a at a seventh step in the molding process, wherein the first and second mold halves are opened to the second opened position, enabling the removal of the completed hollow article.

FIG. 2 illustrates aspects of the bonding flange, according to a first embodiment.

FIG. 3 illustrates aspects of a prior art weld flange.

FIG. 4 illustrates aspects of a bonding interface between opposing bonding flanges of the design according to FIG. 2.

FIGS. 5a through 5d illustrate alternative designs for the bonding flange.

FIGS. 6a through 6f illustrate an alternative molding system wherein the hollow article includes internal walls that are ribbed.

FIGS. 7a through 7f illustrate a further alternative molding system wherein the hollow article includes internal walls that are tapered.

### DETAILED DESCRIPTION

Specific embodiments of the present disclosure will now be described with reference to the Figures, wherein like reference numbers indicate identical or functionally similar elements. The following detailed description is merely exemplary in nature and is not intended to limit the disclosure or the application and uses of the disclosure. A person skilled in the relevant art will recognize that other configurations and arrangements can be used without departing from the scope of the disclosure. Furthermore, there is no intention to be bound by any expressed or implied theory presented in the preceding technical field, background, brief summary, or the following detailed description.

Molding System Features

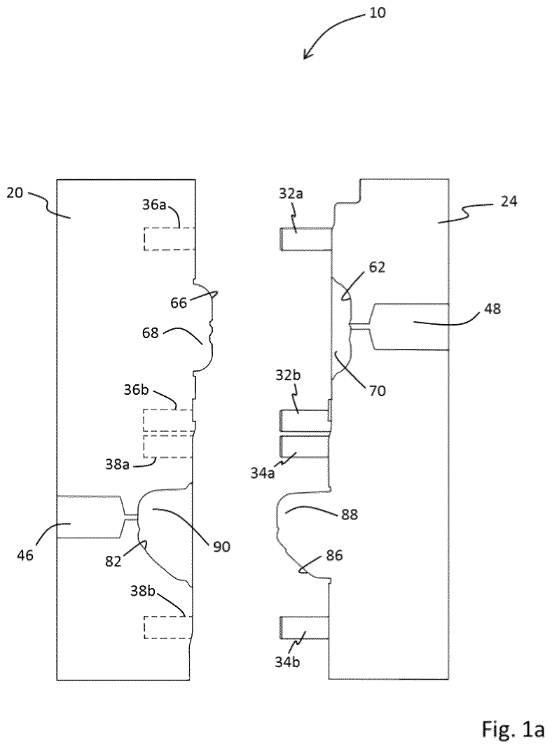

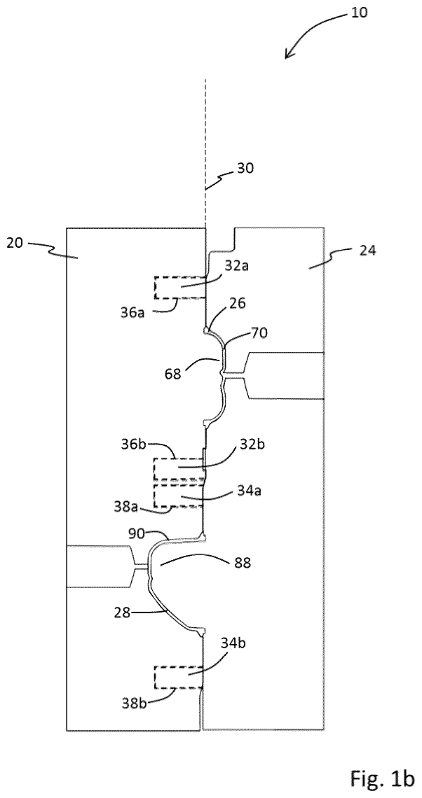

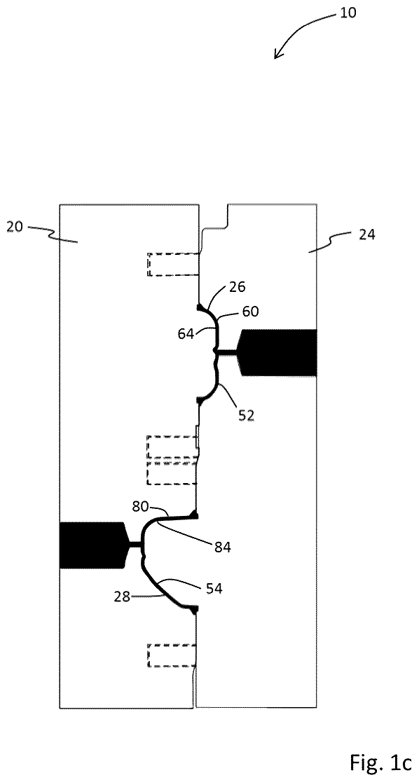

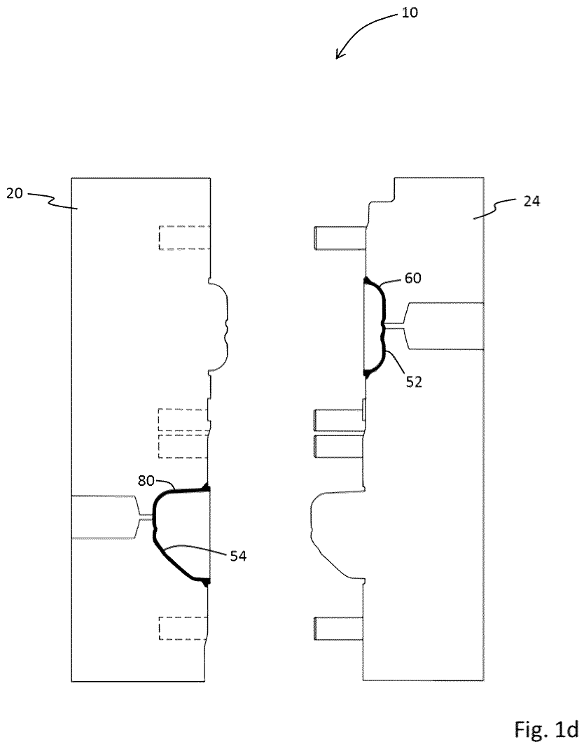

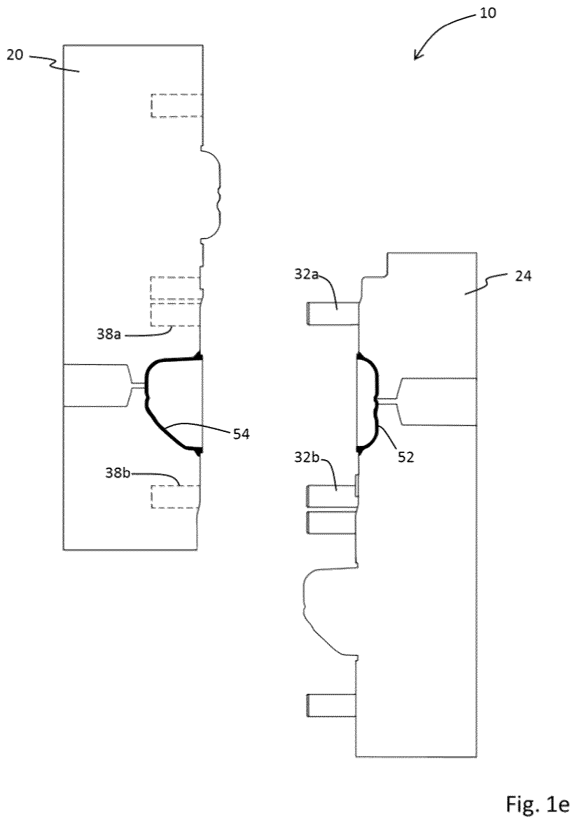

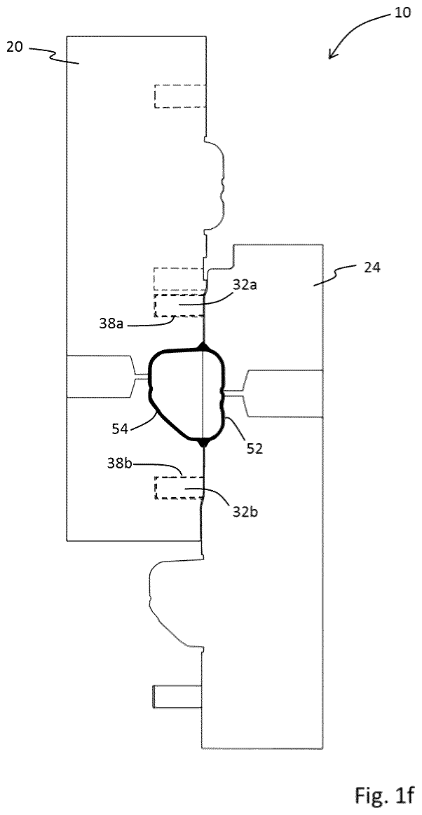

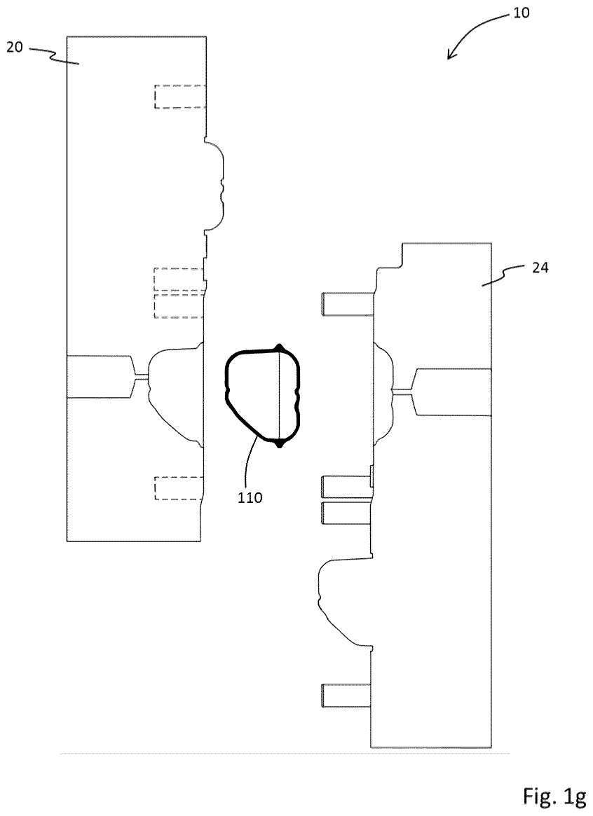

Turning now to FIGS. 1a through 1g, an injection molding system 10 is shown for the manufacture of hollow articles. The molding system 10 as shown of course does not include all parts which are conventionally found in a molding apparatus, since the molds of this invention may be used in conventional molding machinery, and may be manufactured in accordance with conventional design, except as otherwise specifically disclosed herein.

The injection molding system 10 comprises a first mold half 20 and a second mold half 24 which may be conventionally moved between an open position, as shown in FIG. 1a, and a closed position, as shown in FIG. 1b. To achieve this, the first mold half 20 is mounted upon a moveable machine platen (not shown), while the second mold half 24 is mounted upon a stationary machine platen (not shown). As will be detailed in the discussion that follows, the molding system 10 is configured to be closed in two arrangements. Accordingly, the closed position as shown in FIG. 1b is herein referred to as the first closed position. The first and second mold halves 20, 24 together define a plurality of molding cavities in the first closed position. As shown in FIG. 1b, the molding system 10 defines a first molding cavity 26 and a second molding cavity 28. As is conventional, the first mold half 20 and the second mold half 24 define a parting line 30 between them in the first closed position.

The second mold half 24 defines at least one registration projection that mates with a corresponding registration recess on the first mold half 20, to ensure correct alignment of the first and second mold halves 20, 24 at the parting line 30. As shown, the second mold half 24, in the vicinity of the first molding cavity 26, includes a first arrangement of registration projections 32a, 32b; similarly, the second mold half 24, in the vicinity of the second molding cavity 28, includes a second arrangement of registration projections 34a, 34b. On closure of the molding system 10 to the first closed position as shown in FIG. 1b, the first arrangement of registration projections 32a, 32b mate with a first arrangement of registration recesses 36a, 36b provided on the first mold half 20; similarly, on closure of the molding system 10 to the first closed position, the second arrangement of registration projections 34a, 34b mate with a second arrangement of registration recesses 38a, 38b, again provided on the first mold half 20. It will be appreciated that other embodiments may implement alternative arrangements of the registration projections and recesses. The arrangement detailed herein is merely exemplary. For instance, while the registration projections are shown as part of the second mold half 24, in an alternative embodiment they may be provided on the first mold half. In such an embodiment, the corresponding registration recesses would be provided on the opposing mold half, namely the second mold half. In still further alternative embodiments, each mold half may include a combination of projections and recesses, with the opposing mold half including the corresponding mating feature to permit for accurate registration on mold closure to the first closed position. It will be appreciated that the arrangement of the registration projections and corresponding registration recesses for each of the first and second molding cavities is such that upon shifting the molding system to the second stage of the process, as discussed in greater detail below, there is a precise alignment between the first and second article components. This is achieved by placing the first arrangement of registration projections 32a, 32b and corresponding registration recesses at a distance to the first cavity 26 that is spatially equidistant with respect to distance between the second arrangement of registration projections 34a, 34b and corresponding registration recesses relative to the second cavity 28.

The molding system 10 is configured to deliver to each of the first and second cavities 26, 28 a thermoplastic melt through a suitable delivery arrangement. As shown, the first mold half 20 provides a first nozzle pocket 46, while the second mold half 24 provides a second nozzle pocket 48. Each of the first and second nozzle pockets 46, 48 is supplied by a suitable melt delivery assembly, as would be conventional for an injection molding environment. For instance, each of the first and second nozzle pockets 46, 48 may be configured to receive a suitable melt nozzle in fluid communication with a hot runner system, supplied with melt from an extruder arranged on the stationary side of the molding system. It will be appreciated that the melt delivery arrangement may be configured in a number of ways, and that the use of a hot runner system to deliver the melt to each of the first and second mold cavities is merely exemplary.

The molding system 10 is configured to mold in one molding operation at least two article components that are subsequently aligned and bonded to achieve the finished follow article. In the embodiment shown, the hollow article is a fluid reservoir, and the molding system 10 is configured to mold a first article component 52 in the first molding cavity 26, and a second article component 54 in the second molding cavity 28. The form of each article component is defined by the form of the respective cavity. As shown, the first article component 52 formed by the first molding cavity 26 has its exterior surface 60 defined by a first molding surface 62 provided on the second mold half 24, and its interior surface 64 defined by a second molding surface 66 provided on the first mold half 20. The second molding surface 66 is provided on a first core 68 that is shaped to seat in a first recess 70 provided in the second mold half 24, in such a matter so as to define the first molding cavity 26 with a predefined cavity wall thickness, on complete closure of the molding system to the first closed position. Similarly, the second article component 54 formed by the second molding cavity 28 has its exterior surface 80 defined by a third molding surface 82 provided on the first mold half 20, and its interior surface 84 defined by a fourth molding surface 86 provided on the second mold half 24. The fourth molding surface 86 is provided on a second core 88 that is shaped to seat in a second recess 90 provided in the first mold half 20, in such a manner so as to define the second molding cavity 28 with a predefined cavity wall thickness, on complete closure of the molding system to the first closed position.

Molding Operation

As will become apparent in the discussion that follows, the molding operation to form the desired hollow article is achieved through a two-stage process. In a first stage, herein referred to a Stage 1, the first and second article components 52, 54 are separately injection molded in the same molding system. In a second stage, herein referred to as Stage 2, the molding system is reconfigured to align and bring into engagement the first and second article components 52, 54. On engagement, the components are assembled into the desired final form, that is the completed hollow article, without the use of a secondary welding step.

Stage 1, Step 1

With reference to FIG. 1a, in Stage 1, Step 1 of the molding operation, the molding system 10 is arranged in a first open position, that is with the first and second mold halves 20, 24 arranged with complementary mold cores and recesses aligned. Accordingly, the first core 68 is aligned to be received in the first recess 70, and the second core 88 is aligned to be received in the second recess 90. Also in alignment are the complementary registration projections and recesses. Accordingly, the first arrangement of registration projections 32a, 32b are aligned to the first arrangement of registration recesses 36a, 36b, while the second arrangement of registration projections 34a, 34b are aligned to the second arrangement of registration recesses 38a, 38b. In the first open position, the molding system can be inspected to ensure a clean and unobstructed molding environment. In addition, in this first open position, the molding system may be loaded with separately formed components such as brackets, sensors, and the like that are intended to be in-molded into the article components.

Stage 1, Step 2

With reference to FIG. 1b, in Stage 1, Step 2 of the molding operation, the molding system is closed to the first closed position. In the first closed position, the first arrangement of registration projections 32a, 32b are received in the first arrangement of registration recesses 36a, 36b, while the second arrangement of registration projections 34a, 34b are received in the second arrangement of registration recesses 38a, 38b. The engagement between complementary registration projections and recesses serve to ensure accurate alignment of the first and second hold halves 20, 24 in the first closed position. In the first closed position, the first core 68 of the first mold half 20 and the first recess 70 of the second mold half 24 cooperatively define the first mold cavity 26. Similarly, the second core 88 of the second mold half 24 and the second recess 90 of the first mold half 20 cooperatively define the second mold cavity 28. At this point, the molding system 10 is ready to receive the thermoplastic melt.

Stage 1, Step 3

With reference to FIG. 1c, in Stage 1, Step 3 of the molding operation, the thermoplastic melt is injected into the first and second mold cavities 26, 28 to form the first and second article components 52, 54, respectively. With the arrangement of the cores/recesses defining each of the first and second article components 52, 54, the first article component 52 is said to be injected into the second mold half 24, while the second article component 54 is said to be injected into the first mold half 20. In addition, as the second mold half 24 is mounted on the stationary machine platen, the first article component 52 is said to be stationary in the molding system 10. Similarly, as the first mold half 20 is mounted on the moveable machine platen, the second article component 54 is said to be moveable in the molding system 10. Once the injection of the thermoplastic melt is largely complete, the molding system 10 continues to remain closed and the newly formed first and second article components 52, 54 in the respective first and second mold cavities 26, 28 are subject to a predetermined packing pressure/time, to ensure a complete fill of the first and second mold cavities 26, 28, and therein reduce the extent of component shrinkage.

Stage 1, Step 4

With reference to FIG. 1d, in Stage 1, Step 4 of the molding operation, the molding system is opened or returned to the first open position. The first article component 52 remains with the second mold half 24, while the second article component 54 remains with the first mold half 20. More specifically, the exterior surface 60 of the first article component 52 remains seated against the first molding surface 62 provided on the second mold half 24, while the exterior surface 80 of the second article component 54 remains seated against the third molding surface 82 provided on the first mold half 20. With the molding system in the first open position, and with the thermoplastic material defining the first and second article components 52, 54 still in a rubbery/malleable state, internal components such as pumps, sensors, and the like that are intended to be positioned into the interior space of the finished hollow article can be located on the interior surface. The positioning of internal components can be achieved using a suitable positioning means including but not limited to manual insertion and robotic insertion (i.e., by suitable end-of-arm tooling).

Stage 2, Step 5

With reference to FIG. 1e, in Stage 2, Step 5 of the molding operation, the moveable first mold half 20 is displaced to a second open position in which the second article component 54 is positioned in-line with the first article component 52. For greater clarity, the second article component 54 is considered to be in-line with the first article component 52 when upon mold closure (as will be described in the following step), the walls defining each of the first and second article components 52, 54, in particular the walls that establish the outer boundary of the hollow article fully match up at the interface 100 therebetween as shown in FIG. 1f. As will be described in greater detail below, the interface 100 is defined by an interface surface provided on each of the first and second article components. The interface surface is formed as part of a bonding flange, and it is along the flange of each article component that is configured to bond to the opposing article component. In the second open position, the registration projections and recesses are also in alignment, to further establish greater accuracy with respect to the positioning of the moveable first mold half 20 relative to the stationary second mold half 24. As shown, in the second open position, the first arrangement of registration projections 32a, 32b on the second mold half 24 are aligned to the second arrangement of registration recesses 38a, 38b on the first mold half 20.

Stage 2, Step 6

With reference to FIG. 1f, in Stage 2, Step 6 of the molding operation, mold system 10 is closed to a second closed position. In the second closed position, the first arrangement of registration projections 32a, 32b are received in the second arrangement of registration recesses 38a, 38b, to ensure an accurate positioning of the moveable first mold half 20 relative to the stationary second mold half 24. In particular, the accuracy in alignment at this step of the process serves to ensure the first article component 52 is aligned to the second article component 54 at the interface 100 therebetween. Upon closure of the mold system 10 to the second closed position, the flange defining the interface for the first article component 52 engages and bonds to the flange defining the interface for the second article component 54. As such, the finished hollow article is fully assembled within the mold system 10, without the need to eject either separately formed article component, therein ensuring greater dimensional stability in the finished product including less warping. With engagement and bonding of the opposing flanges complete, the mold system 10 is subject to cooling. Cooling time can be optimized as the finished hollow article is fully assembled or enclosed, and there is less likelihood for warpage or other defects that might require longer cooling times.

Stage 2, Step 7

With reference to FIG. 1g, in Stage 2, Step 7 of the molding operation, mold system 10 is opened or returned to the second opened position. Once the assembled hollow article 110 has reached the safe and acceptable ejection temperature, the mold system 10 is opened to permit the part to be ejected. With the mold system 10 emptied of the formed hollow article 110, the moveable first mold half 20 can be returned to the first open position, as shown in Stage 1, Step 1 of the process, and readied for another molding cycle.

Flange Geometry

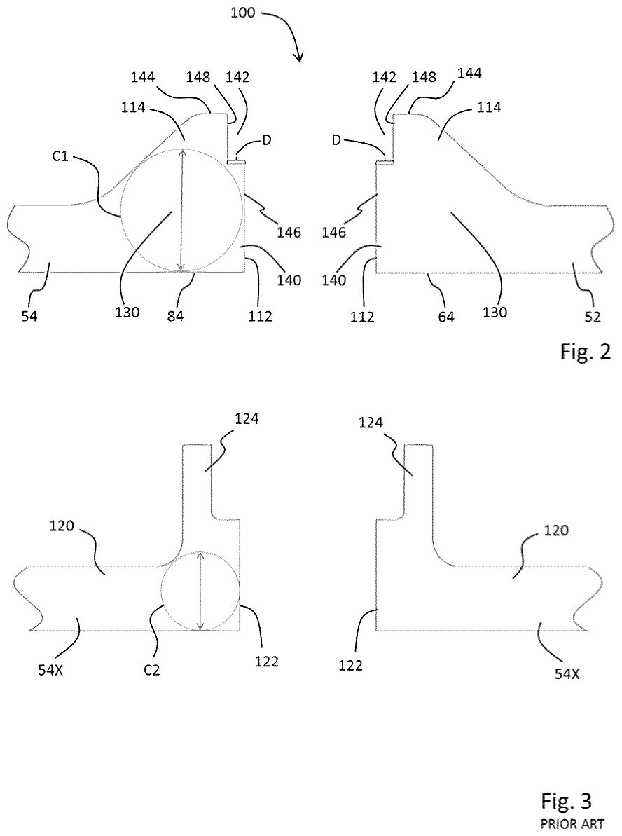

Turning now to FIG. 2, shown is the interface 100 between the first article component 52 and the second article component 54. As stated earlier, the first and second article components 52, 54 are composed of walls that establish the outer boundary of the hollow article to be formed. The interface 100 is the portion of the walls of each of the first and second article components that engage and bond during the second mold system closure, that is to the second closed position, as detailed above in Stage 2, Step 6 and shown in FIG. 1f. The interface 100 is defined by engagement surface 112 on each of the first and second article components 52, 54. The engagement surface 112 is provided on a respective bonding flange 114 on each of the first and second article components 52, 54.

In a conventional post-mold welding operation, a weld flange is provided at the interface between the components to be bonded together. A conventional weld flange 120 is shown in FIG. 3. The weld flange 120 includes an engagement surface 122, and a peripheral rim 124 that permits for mechanical engagement of the components 52x, 54x during the welding operation, for example to draw the components 52x, 54x together at the interface therebetween. The peripheral rim 124 also permits for other assembly fasteners to be used, such as snap features or threaded fasteners. The weld flange 120 in a conventional process is permitted to cool with the article component once removed from the molding system, and is later reheated by a suitable re-heating process, including but not limited to hot plate heating, IR heating, etc. Due to poor thermal conductivity of thermoplastics, re-heating of the weld flange after completion of the molding process in the conventional welding process creates a thermal gradient across the thickness of the weld flange. In general, the thermoplastic closer to the reheated surface of the weld flange has a higher temperature than the thermoplastic towards the center of the weld flange. In some instances, while the reheated engagement surface of the interface exhibits a temperature that is +/−5° C. of the targeted molding temperature (i.e. 225° C.), the internal temperature of the weld flange decreases at a rate of approximately 10° C. per mm away from the reheated surface. In contrast, in the present invention, the area of the enlarged bonding flange is largely uniform, with a melt temperature that is within +/−5° C. of the molding temperature (i.e. 225° C.), where the lowest temperature is generally located at the boundary surface (approx. 0.5 mm) with the ambient air and possibly the mold cavity surface. Accordingly, the bonding between the opposing engagement surfaces is not only at the molten boundary surface, but involves a larger extent of internal molten material of the bonding flange, resulting in a more robust bonding at the interface.

Returning to FIG. 2, the bonding flange 114 of each of the first and second article components 52, 54 is configured in a manner to improve the fusion at the interface formed during Stage 2, Step 6 as detailed above. In comparison to the prior art, the peripheral rim 124 and other sharp corners of the prior art weld flange 120 are removed, to reduce the heat loss of the molten plastic while the molding system 10 is in the second open position. Also, the bonding flange 114 is provided with a melt bank 130 that includes an area of increased thickness to preserve the heat in the flange area. Having regard to FIG. 2, the melt bank 130 is generally denoted by the inscribed circle C1; an inscribed circle C2 is also provided on the prior art weld flange 120 for comparison. As shown, the diameter of the inscribed circle C1 of the bonding flange 114 is greater than the diameter of the inscribed circle C2 of the prior art design. The increase in diameter of the inscribed circle C1 relative to the inscribed circle C2 will be in the range of 10% to 100%, or any subrange therein, such as 20% to 90%, 30% to 80%, 40% to 70%, or 50% to 60%. In a specific example, the increase in diameter of the inscribed circle C1 relative to the inscribed circle C2 will be 50%. In other words, in comparison to the prior art designs, the bonding flange 114 is provided with an increased amount of material, and a decreased surface area to allow for better heat retention. With this configuration, once the predetermined packing pressure/time is complete, the bonding flanges 114 remain rubbery, thermally uniform, and malleable, which are the desirable properties for the in-mold fusion step that occurs at Stage 2, Step 6. It will be appreciated that by performing the fusion step in the molding environment, the article components 52, 54 have not gone through a cooling step, so the bonding flanges remain in the generally uniform thermal state, as described above.

Continuing with FIG. 2, it will be noted that the engagement surface 112 of each respective bonding flange 114 is provided with a step 140, located proximal to the interior surface 64, 84 of each respective article component 52, 54. As shown, the step 140 covers approximately 70% of the engagement surface 112, with the remainder (i.e. 30%) being the recess 142. For clarity, the engagement surface 112 is the portion of the bonding flange 114 that engages the opposing bonding flange 114, and includes the entirety of the interface region between the interior surface 64, 84 and the distal flange outer wall 144, in particular a first face 146 defined by the step 140, and a second face 148 defined by the recess 142. The proportion of the engagement surface 112 that is configured as the step 140 may vary, depending on the specific behavior of the thermoplastic being used for the article components. The step 140 may be configured to occupy anywhere from 5 to 95% of the engagement surface 112, or any sub-value therein, such as 10%, 20%, 30%, 40%, 50%, 60%, 70%, 80%, or 90%. The projection of the step 140, that is the distance D of the first face 146 relative to the second face 148 of the recess 142 may vary, depending on the specific behavior of the thermoplastic being used for the article components. The distance D may range from 0.5 mm to 2.0 mm, or any sub-value therein, such as but not limited to 0.75 mm, 1.0 mm, 1.25 mm, 1.50 mm, or 1.75 mm.

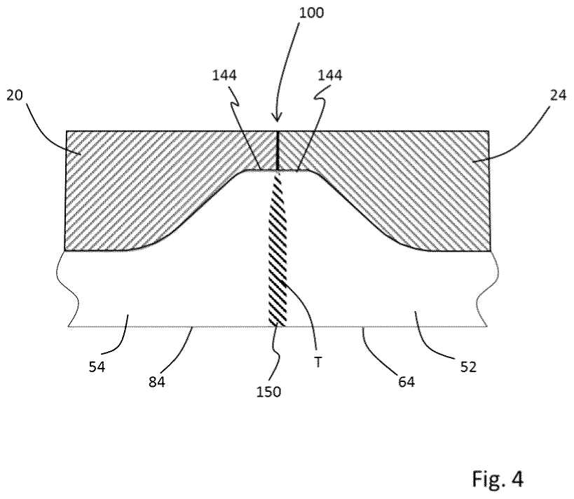

Turning now to FIG. 4, shown is the interface 100 on complete mold closure in Stage 2, Step 6 of the molding operation. At this step of the process, the opposing steps 140 of the first and second article components 52, 54 blend at the interface, forming a bonding region 150. The closure of the molding system 10 is configured to engage the opposing steps 140 a distance of distance D, such that extra thermoplastic melt fills the adjacent recess 142. Accordingly, the bonding region 150 extends along the entire engagement surface 112 between the interior surface 64, 84 and the distal flange outer wall 144. As the opposing steps 140 each engage a distance of distance D, the extent of engagement includes the distance overlap. For instance, where the distance D for the step 140 is 1 mm, the distance overlap is considered to be 2× the step, in this case 2 mm. Where the opposing steps 140 overlap, there is also an increased blending of thermoplastic, resulting in a greater bond in the bonding region 150, as evidenced by the increased thickness at T, relative to the bonded area closer to the distal flange outer wall 144.

In some embodiments, within each of the first and second mold halves 20, 24, a cooling functionality may be provided to subject the formed article components to cooling prior to being ejected from the mold. Where cooling is performed prior to part removal from the molding system, to ensure the aforementioned thermal uniformity in the bonding flanges 114, the area of the first and second mold halves 20, 24 forming the flanges should be exempt from cooling during the molding/packing stages of the process. In this way, it can be ensured that the bonding flanges 114 are at their highest possible thermal state during the bonding stage of Stage 2, Step 6 as shown in FIG. 1f.

Alternate Flange Configurations

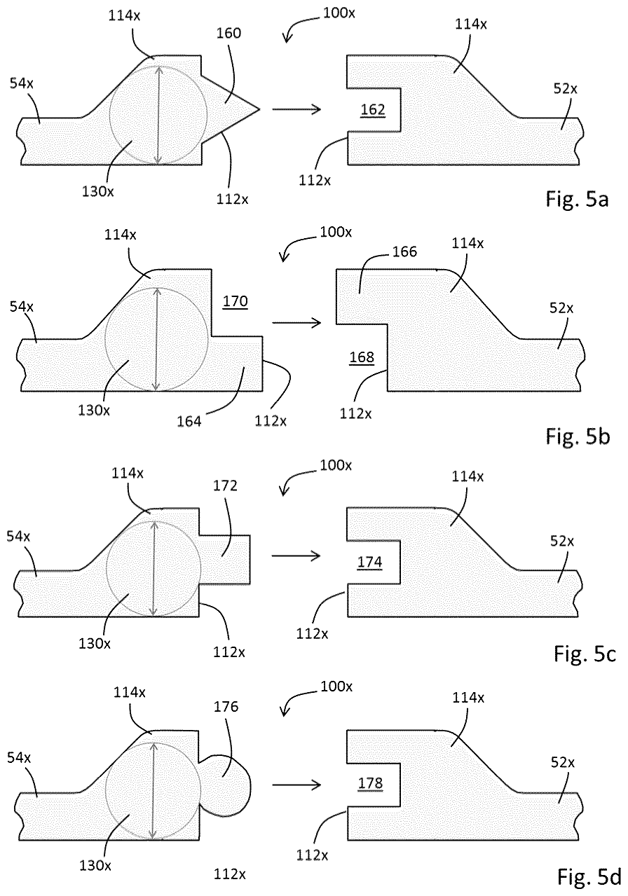

The stepped configuration of the bonding flange 114 as detailed in FIGS. 2 and 4 has been found to be particularly effective in providing a solid bonded interface between the first and second article components 52, 54. While this is the preferred configuration of the bonding flange, other alternative configurations may be used in certain circumstances. With reference to FIGS. 5a to 5d, shown are a selection of alternative flange designs.

Each of the alternative embodiments shown include the melt bank 130x as previously discussed, to promote enhanced heat retention in the area of the bonding flange. In addition to the melt bank 130x, each of the bonding flanges shown provide an alternative bonding interface. More specifically, the interface 100x between each respective first and second article component 52x, 54x, in particular the engagement surfaces 112x on each of the opposing bonding flanges 114x are shaped to promote engagement therebetween. The engagement surfaces 112x are molded with complementary shapes to achieve an increased blending of thermoplastic material, resulting in a greater bond in the bonding region. With reference to FIG. 5a, the engagement surfaces 112x are presented in the form of a triangular projection 160 provided on the second article component 54x, and a square/rectangular recess 162 provided on the first article component 52x. With reference to FIG. 5b, the engagement surfaces 112x are presented in the form of a square/rectangular tab 164 provided on the second article component 54x, and a similar square/rectangular tab 166 provided on the first article component 52x. The square/rectangular tabs 164, 166 are offset in a manner that seats each tab in a respective opposing recess 168, 170. With reference to FIG. 5c, the engagement surfaces 112x are presented in the form of a square/rectangular projection 172 provided on the second article component 54x, and a square/rectangular recess 174 provided on the first article component 52x. With reference to FIG. 5d, the engagement surfaces 112x are presented in the form of a circular projection 176 provided on the second article component 54x, and a square/rectangular recess 178 provided on the first article component 52x.

Internal Wall Structures

The discussion thus far has focused primarily upon hollow articles without internal wall structures. It will be appreciated that the technology described above may also find application in situations where the hollow article is configured with internal walls, for example to subdivide the internal volume into multiple chambers.

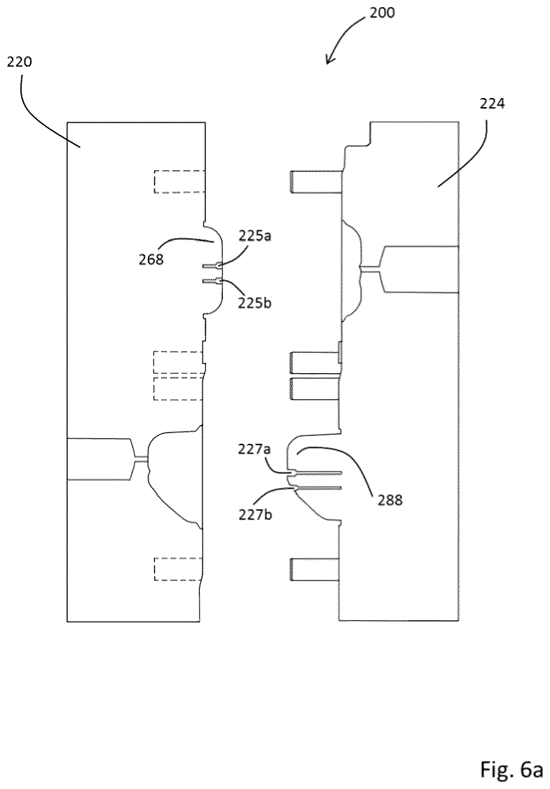

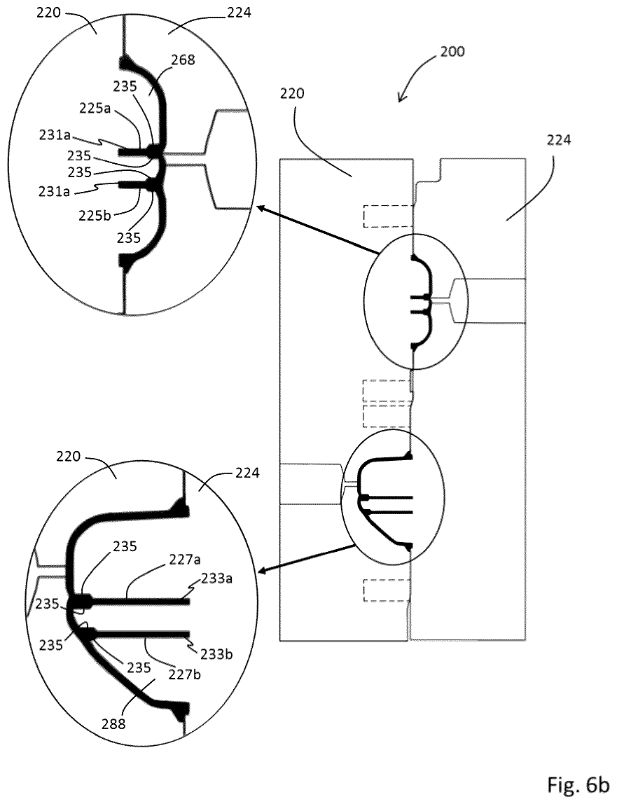

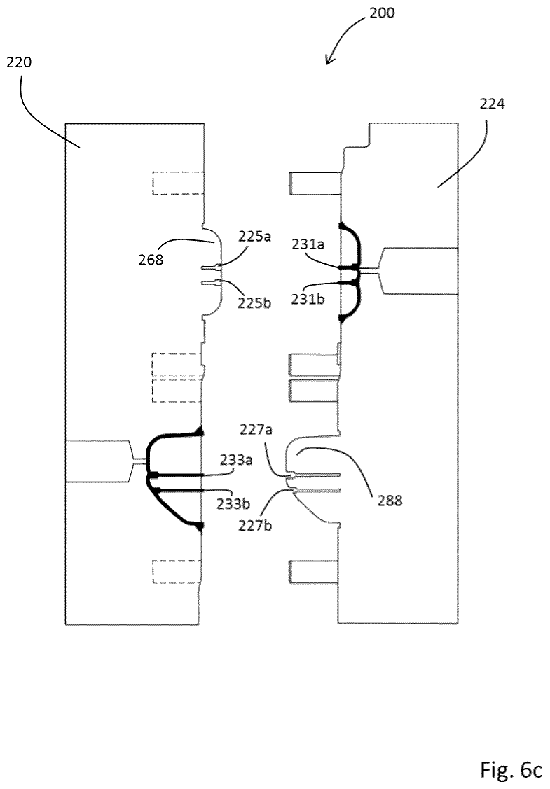

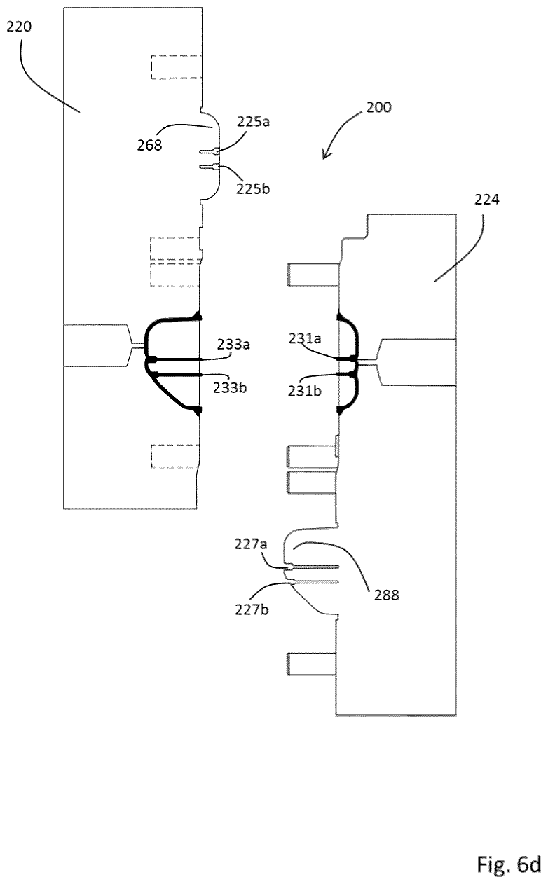

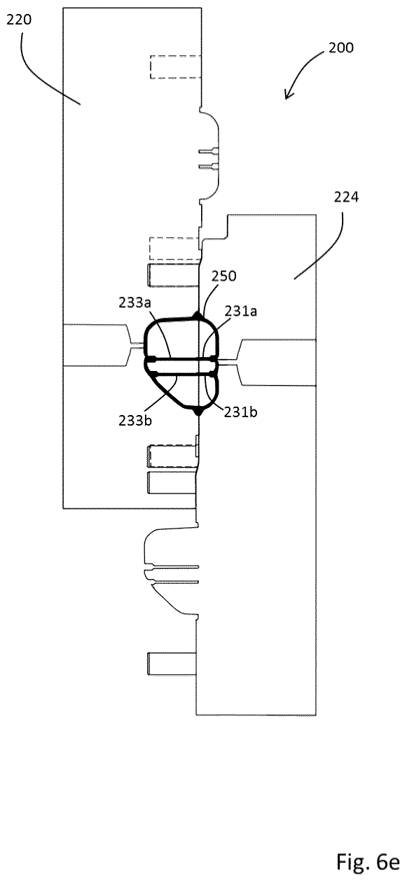

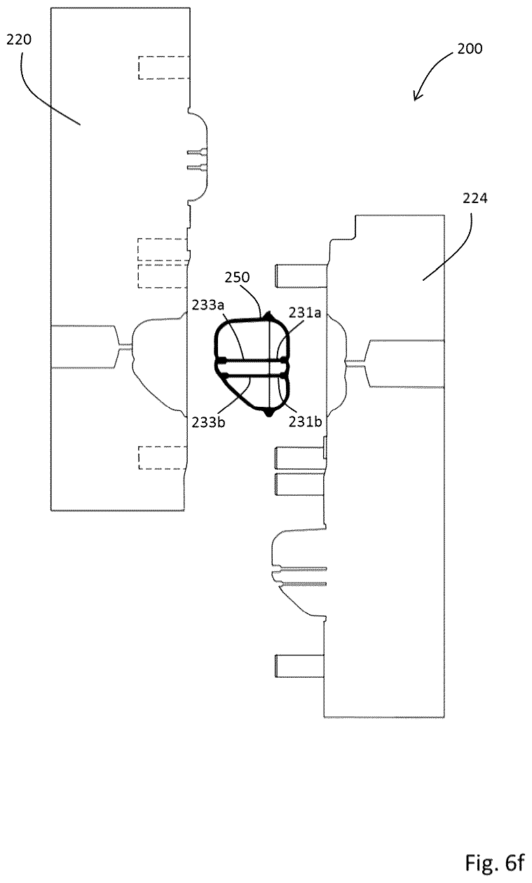

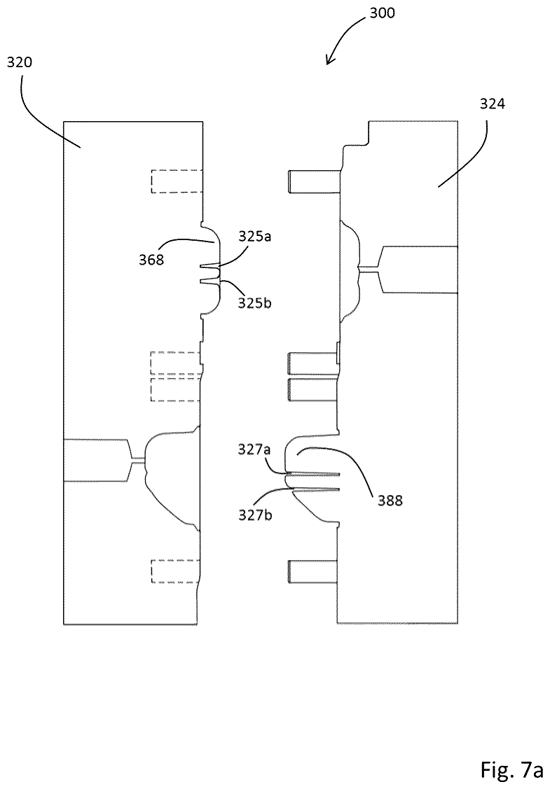

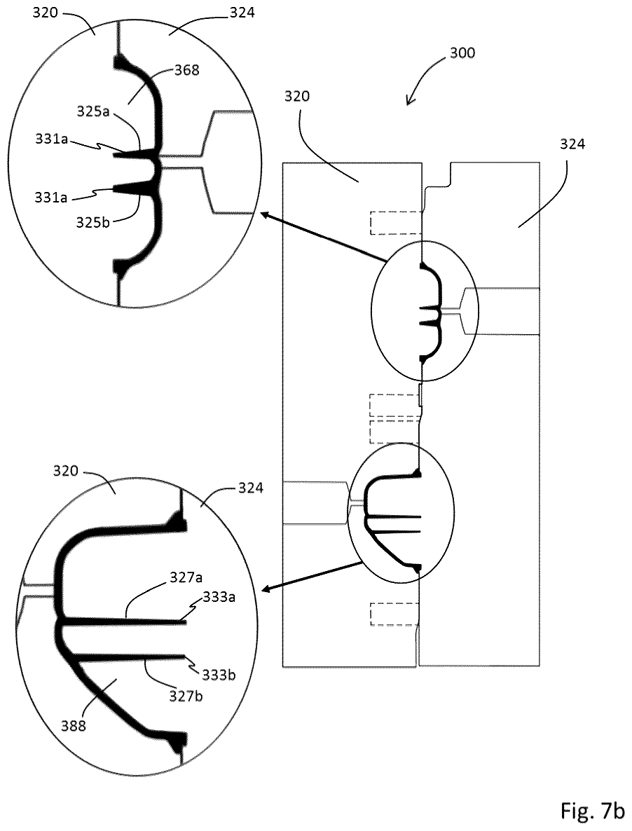

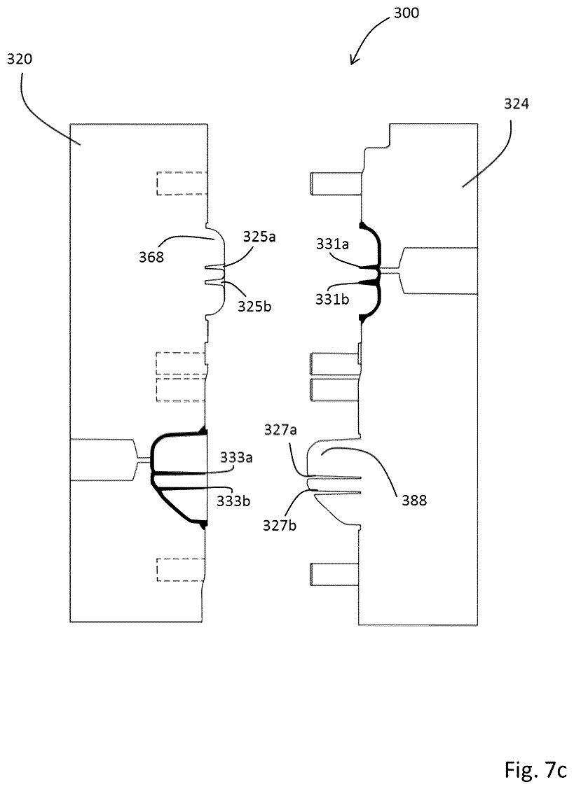

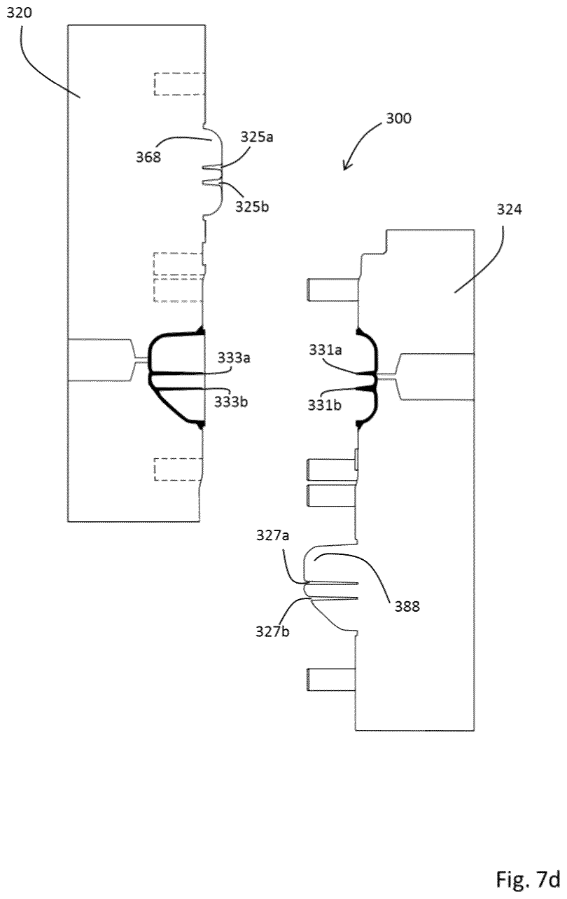

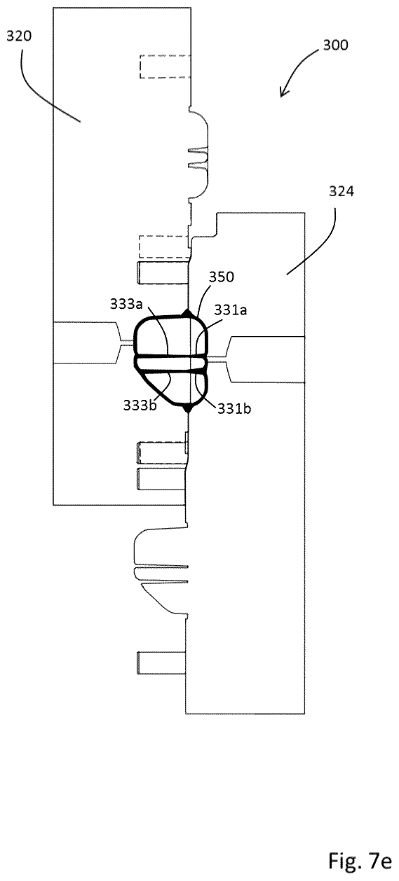

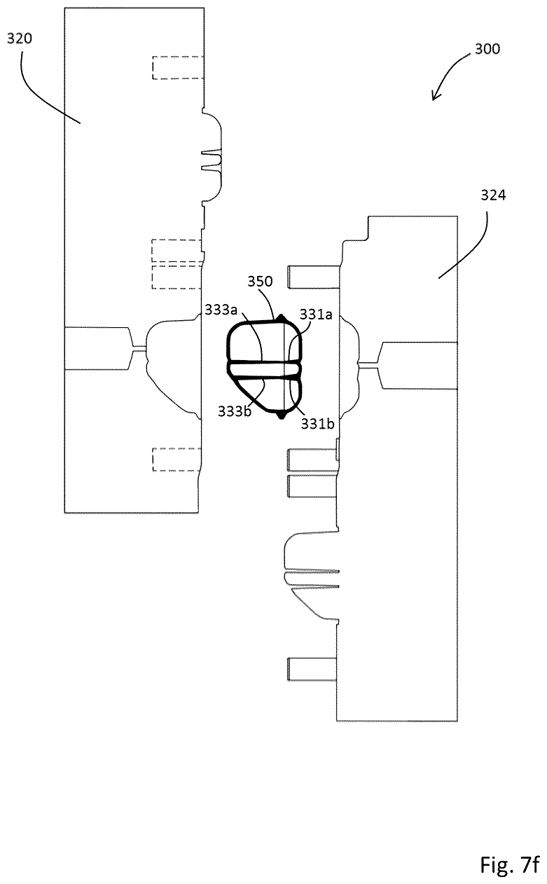

With reference to FIGS. 6a to 6f, and FIGS. 7a to 7f, shown are two molding systems 200, 300, each configured to manufacture a hollow article having at least one internal wall structure. It will be appreciated that the molding systems 200, 300 are identical to the molding system 100 previously discussed, with the exception of additional molding elements (i.e. cavities) to form the internal walls. As such, the molding systems 200, 300 will not be described in detail herein. The discussion that follows will focus solely upon the differences found in each of the molding systems 200, 300 having regard to the detailed description of the molding system 100.

With reference first to FIGS. 6a to 6f, the molding system 200 is configured to form internal walls having at least one rib. The rib serves to provide additional free-standing structure to the internal wall during the assembly process, in particular during Stage 2 of the molding operation. To achieve this, the first core 268 presented on the first mold half 220 presents molding features (i.e. molding cavities) to form at least a portion of the internal wall. As shown, the first core 268 presents molding cavities 225a, 225b (collectively 225). Similarly, the second core 288 presented on the second mold half 224 presents similar molding features (i.e. molding cavities) to form a complimentary portion of the internal wall. As shown, the second core 288 presents molding cavities 227a, 227b (collectively 227). With reference to FIG. 6b, shown is Stage 1, Step 3 of the molding operation. It can be seen that the molding cavities 225 serve to form a first internal wall portion 231a, 231b (collectively 231), while the molding cavities 227 serve to form a second internal wall portion 233a, 233b (collectively 233). Each of the first and second internal wall portions 231, 233 include the at least one rib 235. The rib 235 may be configured to extend over only a portion of the internal wall (as shown), or along the entire length. In addition, the internal walls may include multiple ribs 235 to ensure the required free-standing stability required for the remaining steps of the molding operation. Continuing with the Figures, the molding operation includes the same series of molding and assembly steps as previously described. With specific reference to FIG. 6e, Stage 2, Step 6 of the molding process is shown, wherein the first and second mold halves 220, 224 are closed to the second closed position. In addition to the bonding occurring along the bonding flange as previously described, the abutment of the first and second internal wall portions 231, 233 serve to engage and bond the internal wall portions in a manner to present a unitary internal wall structure in the final assembled hollow article 250.

With reference to the alternative embodiment shown in FIGS. 7a to 7f, the molding system 300 is configured to form tapered internal walls. The taper serves to provide additional free-standing structure to the internal wall during the assembly process, in particular during Stage 2 of the molding operation. To achieve this, the first core 368 presented on the first mold half 320 presents molding features (i.e. molding cavities) to form at least a portion of the internal wall. As shown, the first core 368 presents molding cavities 325a, 325b (collectively 325). Similarly, the second core 388 presented on the second mold half 324 presents similar molding features (i.e. molding cavities) to form a complimentary portion of the internal wall. As shown, the second core 388 presents molding cavities 327a, 327b (collectively 327). With reference to FIG. 7b, shown is Stage 1, Step 3 of the molding operation. It can be seen that the molding cavities 325 serve to form a first internal wall portion 331a, 331b (collectively 331), while the molding cavities 327 serve to form a second internal wall portion 333a, 333b (collectively 333). Each of the first and second internal wall portions 331, 333 are at least partially tapered. The taper may be configured to extend over only a portion of the internal wall (as shown), or along the entire length. The configuration of the taper is selected to ensure the required free-standing stability required for the remaining steps of the molding operation. Continuing with the Figures, the molding operation includes the same series of molding and assembly steps as previously described. With specific reference to FIG. 7e, Stage 2, Step 6 of the molding process is shown, wherein the first and second mold halves 320, 324 are closed to the second closed position. In addition to the bonding occurring along the bonding flange as previously described, the abutment of the first and second internal wall portions 331, 333 serve to engage and bond the tapered internal wall portions in a manner to present a unitary internal wall structure in the final assembled hollow article 350.

While the internal walls are shown to include ribs and/or tapers to enhance the free-standing stability of the internal walls, the internal walls may also be provided with other features, either molded or provided as in-molded or overmolded elements to ensure accuracy and adequate bonding of the internal wall portions during the molding and assembly operation.

Cooling of Article Components

As stated above, a cooling functionality may be provided in each of the first and second mold halves 20, 24, with the exception of in the region of the bonding flanges 114. The cooling functionality is generally provided in the form of cooling water channels machined into the mold tool. Cooling provided in this form is primarily conductive. The cooling can continue as long as the first and second article components 52, 54 are in contact with the molding surfaces of the mold tool. The arrangement of the cooling channels can take on a variety of configurations. For example, in one embodiment, the cooling channels can be located on one side of the mold cavity, that is within the mold tool on the side including the molding recess 70, 90. In another embodiment, the cooling channels can be located again on one side of the mold cavity, but within the mold tool on the side including the molding core 68, 88. In yet another embodiment, the cooling channels can be located on both sides of the mold cavity, that is within the mold tool on both the side including the molding recess 70, 90, and the side including the mold core 68, 88. When the cooling channels are located on both sides of the mold cavity, both sides of the injection molded article component are cooled when the molding system 10 is in the first closed position. Cooling on both sides of the first and second article components continues until completion of the packing stage of the process. Upon opening the molding system 10 and moving the first mold half 20 to the second opened position, only the outside of each of the first and second article components 52, 54 continue to be cooled.

In some embodiments, additional post mold/post-fusion cooling may be applied to the inside of the finished hollow article by applying cooling air through available ports included on the finished article. In general, internal cooling is not necessary since the shape of the hollow object is completed, and there is little concern for the extra heat trapped inside the object. The heat will naturally dissipate via the existing ports as well as natural convection with the ambient temperature.

Materials

Hollow articles that may be manufactured in accordance with the above process may be made of any suitable thermoplastic, including but not limited to polypropylene, polyethylene, and Nylon. The thermoplastic may also include various fillers known in the art, including but not limited to mineral fillers such as calcium carbonate, talc, and the like as well as additives, including but not limited to fibrous additives such as glass fibers, carbon fibers, and the like.

### Advantages

The aforementioned process has a number of advantages. The process serves to eliminate the secondary welding step that conventionally take place outside of an injection molding system. As such, the process provides the ability to install in-mold sensors, components, special labels, or the like on the inside of the object by an EOAT during the axial shifting of the moving half and before mold closing. The process also eliminates or reduces potential warpage and leakage because the fusion of the two halves of the object within this process occurs at a time that the halves are still to the size of the steel tool. The process also eliminates the reheat cycle that the weld flange is exposed to, and eliminates the capital investment related to the required welding press, welding nest and other secondary assembly equipment. The process reduces cycle time, eliminates the manpower, eliminates the scrap related to conventional welding process, and provides design freedom for features that could be integrated rather than relying on secondary processes for assembly.

While the above discussion has primarily dealt with the manufacture of hollow articles, the process described herein may also find application in the manufacture of other thermoplastic articles that are not hollow, but may possess design attributes that require in-mold assembly.

Relative terms should be construed as such. For example, the term “upper” is meant to be relative to the term “lower,” the term “horizontal” is meant to be relative to the term “vertical”, the term “top” is meant to be relative to the term “bottom”, “inside” is relative to the term “outside”, “upwards” is meant to be relative to the term “downwards”, and so forth. Unless specifically stated otherwise, the terms “first,” “second,” “third,” and “fourth” are meant solely for purposes of designation and not for order or for limitation.

While various embodiments have been described above, it should be understood that they have been presented only as illustrations and examples of the present disclosure, and not by way of limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

1. A molding system for molding a thermoplastic article, the molding system comprising,
a first mold half;
a second mold half;
the first and second mold halves together defining a plurality of molding cavities in a first closed position;
wherein the plurality of cavities serve to mold a corresponding plurality of article components in a first molding stage;
wherein subsequent the first molding stage the first mold half is displaceable relative to the second mold half to align the plurality of article components formed during the first molding stage; and
wherein during a second molding stage, the first and second mold halves are closed to a second closed position, to engage and bond together the plurality of article components into a finished thermoplastic article.

2. The molding system according to claim 1, wherein the plurality of article components includes a first article component, and a second article component, the first and second article components remaining with respective second and first mold halves on opening the molding system subsequent the first molding stage, and wherein upon displacing the first mold half relative to the second mold half, the first and second article components are aligned at an interface therebetween.

3. The molding system according to claim 2, wherein during the second molding stage, the first and second article components engage and bond together at an interface therebetween.

4. The molding system according to claim 3, wherein the interface includes an engagement surface provided on each of the first and second article components.

5. The molding system according to claim 4, wherein the engagement surface for each of the first and second article components is provided in the form of a bonding flange.

6. The molding system according to claim 5, wherein the bonding flange includes a melt bank having an area of increased thickness relative to a conventional weld flanges, the thickness being defined as an inscribed circle having a diameter, and wherein the diameter of the inscribed circle of the melt bank is from 10 to 100% greater than the inscribed circle of the convention weld flange.

7. The molding system according to claim 5, wherein the bonding flange is provided with a projected step located proximal an interior surface of each respective article components.

8. The molding system according to claim 7, wherein the step occupies from 5 to 95% of the engagement surface of the molding flange.

9. The molding system according to claim 7, wherein the step defines along the engagement surface a first face on the projected portion, and a second face on the non-projected portion, the extend of the projection between the first and second faces being from 0.5 mm to 2.0 mm.

10. The molding system according to claim 1, wherein the plurality of article components define an outer boundary of the intended finished thermoplastic article.

11. The molding system according to claim 10, wherein the plurality of article components additionally define one or more internal wall structures.

12. The molding system according to claim 11, wherein the internal wall structures are provided with ribs to enhance their free-standing stability prior to stage 2 of the molding process.

13. The molding system according to claim 11, wherein the internal wall structures are tapered to enhance their free-standing stability prior to stage 2 of the molding process.

14. A process for molding a thermoplastic article in a molding system, the process comprising,
a first stage in which two or more article components are formed in separate molding cavities;
a second stage in which the molding system changes in configuration to align and bring into engagement the two or more article components to permit for bonding therebetween;
wherein each of the two or more article components are provided with a bonding flange that serves as the interface between components to be bonded together, and
wherein throughout both the first stage and the second stage the bonding flange is maintained at substantially the molding temperature of the thermoplastic being used, until the thermoplastic article is formed.
